(19) United States
(12) Patent Application Publication
(10) Pub. No.: US 2015/0364798 A1
(43) Pub. Date: Dec. 17, 2015

(54) POSITIVE ELECTRODE FOR LITHIUM-ION SECONDARY BATTERY AND PRODUCTION PROCESS FOR THE SAME, AND LITHIUM-ION SECONDARY BATTERY

(71) Applicant: KABUSHIKI KAISHA TOYOTA JIDOSHOKKI, Kariya-shi, Aich (JP)

(72) Inventors: Hiroki OSHIMA, Kariya-shi (JP); Takeshi MAKI, Kariya-shi (JP)

(73) Assignee: KABUSHIKI KAISHA TOYOTA JIDOSHOKKI, Kariya-shi, Aichi (JP)

(21) Appl. No.: 14/762,221

(22) PCT Filed: Jan. 21, 2014
(86) PCT No.: PCT/JP2014/000280

§ 371 Date: Jul. 21, 2015

(30) Foreign Application Priority Data
Jan. 23, 2013 (JP) 2013-009971
Mar. 25, 2013 (JP) 2013-062506

(51) Int. Cl. H01M 10/42; H01M 10/0525; H01M 4/505; H01M 4/525; H01M 4/62; H01M 10/0568

(52) U.S. Cl. CPC H01M 10/4235; H01M 4/62; H01M 10/0568; H01M 4/505; H01M 4/525; H01M 10/0525; H01M 2004/028

(57) ABSTRACT

A positive-electrode active-material layer is formed of positive-electrode active-material particles including an Li compound or solid solution selected from the group consisting of LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ (note that 0.5≦“x”≦1.5, 0.1≦“a”<1, 0.1≦“b”<1 and 0.1≦“c”<1); a binding portion not only binding the positive-electrode active-material particles together one another but also binding the positive-electrode active-material particles together with the current collector; and an organic/inorganic coating layer covering at least parts of surface of the positive-electrode active-material particles. Since the organic/inorganic coating layer has high joining strength to the Li compound, the positive-electrode active-material particles and an electrolytic solution are inhibitable from contacting directly with one another at the time of a high-voltage driving mode or operation.

### TECHNICAL FIELD

The present invention relates to a positive electrode to be used for lithium-ion secondary battery, to a production process for the same, and a lithium-ion secondary battery using the positive electrode.

### BACKGROUND ART

Lithium-ion secondary batteries have high charged and discharged capacities, and are batteries being able to make the outputs high. Currently, the lithium-ion secondary batteries have been used mainly as power sources for portable electronic appliances, and have further been expected as power sources for electric automobiles anticipated to become widespread from now on. The lithium-ion secondary batteries comprise active materials being capable of inserting and eliminating (or sorbing and desorbing) lithium (Li) in the positive electrode and negative electrode, respectively. And, lithium ions moving within an electrolytic solution disposed between the two electrodes lead to operating the lithium-ion secondary batteries. In the lithium-ion secondary batteries, a lithium-containing metallic composite oxide, such as lithium/cobalt composite oxides, has been used mainly as an active material of the positive electrode; whereas a carbon material with a multilayered structure has been used mainly as an active material of the negative electrode.

However, since the capacity of the current lithium-ion secondary batteries is not possibly said to be satisfactory, making the current lithium-ion secondary batteries exhibit a much higher capacity has been sought for. As an approach for achieving the target, although making a positive-electrode potential a high voltage has been investigated, the investigation has been associated with such a large problem that, when a battery is driven with a high voltage, the battery has extremely deteriorated characteristics after being charged and discharged repeatedly. A cause of the problem has been believed to be the oxidation decompositions of an electrolytic solution and electrolyte which occur in the vicinity of a positive electrode when being charged.

That is, lithium ions consumed by the oxidation decompositions of an electrolyte in the vicinity of a positive electrode are believed to result in declining a capacity. Moreover, an output is believed to decline because the decomposed products of an electrolytic solution depositing on an electrode surface or in the voids of a separator turn into a resistive matter against the lithium-ion conduction. Therefore, to solve such problems, inhibiting the electrolytic solution and electrolyte from decomposing is necessary.

Hence, Japanese Unexamined Patent Publication (KOKAI) Gazette No. 11-097027, Japanese Translation of PCT International Application Publication (KOHYO) Gazette No. 2007-510267, and so on, propose a nonaqueous-electrolyte secondary battery in which a coated layer composed of an ion-conductive polymer, and the like, is formed onto a positive-electrode surface, respectively. The gazettes state that forming the coated layer results in making the following deteriorations inhibitable: the elution of a positive-electrode active material, the decompositions thereof, and so forth.

But, since the gazettes do not at all set forth any evaluation for the nonaqueous-electrolyte secondary batteries when the batteries are charged with such a high voltage as 4.3 V or more, the batteries have not been proved clearly yet whether or not being able to endure such a high-voltage driving mode or operation. Moreover, since the thickness of the coated layers is also on the order of micrometers substantially, the coated layers have turned into a resistance to the lithium-ion conduction.

### PATENT LITERATURE

Patent Application Publication No. 1: Japanese Unexamined Patent Publication (KOKAI) Gazette No. 11-097027; and

Patent Application Publication No. 2: Japanese Translation of PCT International Application Publication (KOHYO) Gazette No. 2007-510267

### SUMMARY OF THE INVENTION

### Technical Problem

The present invention is made in view of the aforementioned circumstances. An object of the present invention is to provide a positive electrode for lithium-ion secondary battery being able to endure a high-voltage driving mode or operation.

### Solution to Problem

Features of a positive electrode for lithium-ion secondary battery according to the present invention solving the aforementioned technical problems lie in that the positive electrode comprises:

a current collector; and

a positive-electrode active-material layer bound together onto the current collector;

the positive-electrode active-material layer comprising: positive-electrode active-material particles including an Li compound or solid solution selected from the group consisting of LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ (note that 0.5≦“x”≦1.5, 0.1≦“a”<1, 0.1≦“b”<1 and 0.1≦“c”<1); a binding portion not only binding the positive-electrode active-material particles together one another but also binding the positive-electrode active-material particles together with the current collector; and an organic/inorganic coating layer covering at least parts of surface of the positive-electrode active-material particles at least;

the organic/inorganic coating layer including: at least one optional polymer selected from polymers with at least one member selected from the group consisting of amino groups, amide groups, imino groups, imide groups, maleimide groups, carboxyl groups and ether groups; and at least one optional metal selected from the group consisting of alkali metals, alkaline-earth metals and rare-earth elements.

And, features of a production process according to the present invention for the present positive electrode for lithium-ion secondary battery lie in that the production process comprises the steps of:

forming a positive-electrode active-material layer by applying a slurry onto a surface of a current collector and then drying the slurry thereon, the slurry comprising a binding agent, and positive-electrode active-material particles including an Li compound or solid solution selected from the group consisting of LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ (note that 0.5≦“x”≦1.5, 0.1≦“a”<1, 0.1≦“b”<1 and 0.1≦“c”<1); and

forming an organic/inorganic coating layer by applying a polymer solution onto the positive-electrode active-material layer and then drying the polymer solution thereon, the polymer solution comprising a solvent, at least one optional polymer dissolved in the solvent and including a polymer selected from polymers with at least one member selected from the group consisting of amino groups, amide groups, imino groups, imide groups, maleimide groups, carboxyl groups and ether groups, and a compound dissolved in the solvent and including at least one optional metal selected from the group consisting of alkali metals, alkaline-earth metals and rare-earth elements.

### Advantageous Effects of the Invention

The positive electrode for lithium-ion secondary battery according to the present invention comprises an organic/inorganic coating layer formed on parts of surface of positive-electrode active-material particles including an Li compound or solid solution selected from the group consisting of LiₓNiₐCo_{b}Mn_{d}O₂, LiₓCo_{b}Mn_{c}O₂, LiₓNiₐMn_{c}O₂, LiₓNiₐCo_{b}O₂ and Li₂MnO₃ (note that 0.5≦“x”≦1.5, 0.1≦“a”<1, 0.1≦“b”<1 and 0.1≦“c”<1). Since the organic/inorganic coating layer covers the positive-electrode active-material particles, the positive-electrode active-material particles are inhibitable from contacting directly with an electrolytic solution when being driven with a high voltage.

And, the organic/inorganic coating layer includes an optional polymer selected from polymers with at least one member selected from the group consisting of amino groups, amide groups, imino groups, imide groups, maleimide groups, carboxyl groups and ether groups, and at least one optional metal selected from the group consisting of alkali metals, alkaline-earth metals and rare-earth elements. Since an optional polymer including nitrogen (N) or a carboxylic group has an unshared electron pair, ions of the optional metal are likely to coordinate to the polymer. Moreover, an optional polymer including an ether group is likely to form complexes with alkali metals, and the like. Therefore, the organic/inorganic coating layer becomes a uniform and dense film. Besides, not only the optional-metal ions make inhibiting resistance from rising greatly possible, but also the optional-metal ions substituting for protons makes adverse effects resulting from protons avoidable, within a battery. Moreover, as far as a thickness of the organic/inorganic coating layer is on the order of from nanometer to sub-micrometer, the organic/inorganic coating layer does not turn into any resistance to the lithium-ion conducting property. Therefore, inhibiting an electrolytic solution from decomposing is possible even when being driven with a high voltage, thereby making a lithium-ion secondary battery, which is not only of high capacity but also is capable of maintaining high battery characteristics even after repetitive charging and discharging mode or operations, providable.

Moreover, since the organic/inorganic coating layer is formable by using a dipping method, roll-to-roll processing becomes feasible so that the productivity upgrades.

### BRIEF DESCRIPTION OF THE DRAWINGS

FIG. 1 shows a TEM image of a positive-electrode active material included in a lithium-ion secondary-battery positive electrode directed to a first example.

### DESCRIPTION OF THE EMBODIMENTS

A positive electrode for lithium-ion secondary battery according to the present invention comprises a current collector, and a positive-electrode active-material layer bound together onto the current collector. As for the current collector, employing current collectors having been used commonly for lithium-ion secondary-battery positive electrodes, and the like, is permissible. For example, the following are exemplified: aluminum foils, aluminum meshes, punched aluminum sheets, aluminum expanded sheets, stainless-steel foils, stainless-steel meshes, punched stainless-steel sheets, stainless-steel expanded sheets, foamed nickel, nickel unwoven fabrics, copper foils, copper meshes, punched copper sheets, copper expanded sheets, titanium foils, titanium meshes, carbon nonwoven fabrics, carbon woven fabrics, and so forth.

When the current collector comprises aluminum, forming an electrically-conductive layer including an electrical conductor on a surface of the current collector, and then forming the positive-electrode active-material layer on a surface of the electrically-conductive layer are desirable. The cyclability of a lithium-ion secondary battery is further upgraded by thus forming the layers. The advantageous effect is believed to result from preventing the current collector from eluting out into an electrolytic solution at the time of high temperatures. As for the electrical conductor, the following are exemplified: carbon (such as graphite, hard carbon, acetylene black and furnace black), ITO (i.e., indium-tin-oxide), tin (Sn), and the like. Forming the electrically-conductive layer of the electrical conductors is possible by a PVD method, a CVD method, and so forth.

Although a thickness of the electrically-conductive layer is not at all restricted especially, setting the thickness at 5 nm or more is preferable. When the thickness becomes thinner than the setting, causing the advantage of upgrading cyclability to take effect becomes difficult.

The positive-electrode active-material layer comprises an innumerable number of positive-electrode active-material particles including a positive-electrode active material, a binding portion not only binding the positive-electrode active-material particles together one another but also binding the positive-electrode active-material particles together with the current collector, and the organic/inorganic coating layer covering at least parts of surface of the positive-electrode active-material particles. The positive-electrode active material includes an Li compound or solid solution selected from the group consisting of LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ (note that 0.5≦“x”≦1.5, 0.1≦“a”<1, 0.1≦“b”<1 and 0.1≦“c”<1). One species of the options is also allowable, or mixing multiple species of the options one another is even permissible. When being multiple species of the options, the multiple species are also allowed to form a solid solution. Moreover, when being a ternary-system positive-electrode active material including all of Ni, Co and Mn, a desirable ternary-system positive-electrode active material has the subscripts making “a”+“b”+“c”≦1. Among the options, the LiₓNiₐCo_{b}Mn_{c}O₂ is especially preferable. Modifying parts of surface of the Li compounds or solid solutions is also allowable. Moreover, covering parts of the surface with an inorganic substance is even permissible. In the instances, the modified surface, and the covering inorganic substance are inclusively referred to as the “positive-electrode active-material particles.”

Moreover, the positive-electrode active materials are also allowed to further include a hetero-atom doped into the crystal structure. An element to be doped, and an amount of the doped element are not limited; however, as the element, the following are preferable: Mg, Zn, Ti, V, Al, Cr, Zr, Sn, Ge, B, As, and Si; and a preferable amount of the element is from 0.01 to 5%.

The binding portion is a part formed by a binder having undergone drying, binds the positive-electrode active-material particles together one another, or binds the positive-electrode active-material particles together with the current collector. A desirable organic/inorganic coating layer is formed onto at least part of the binding portion. Since the thus formed organic/inorganic coating layer protects the binding portion to be enhanced more in the binding strength, the organic/inorganic coating layer enables the conductive additive to be protected from cracking or coming off even after such a severe cycle test as being conducted under a high temperature and a high voltage.

Although the organic/inorganic coating layer includes a conductive additive commonly, a desirable organic/inorganic coating layer is formed on at least part of the conductive additive as well. The thus formed desirable organic/inorganic coating layer enables the conductive additive to be protected.

The organic/inorganic coating layer includes at least one optional polymer selected from polymers with at least one member selected from the group consisting of amino groups, amide groups, imino groups, imide groups, maleimide groups, carboxyl groups and ether groups. As for the optional polymer, the following are exemplified: polyethylene imine, polyallylamine, polyvinylamine, polyaniline, poly diallyldimethylammonium chlorides, polyacrylic acids, polyethylene oxide, polyallylamine, polylysine, polyacrylimide, bismaleimide triazine resins, carboxymethylated polyethylene imine, polymers of phosphate ester, and the like. Including at least one species of the polymers is allowable, and including multiple species thereof is also permissible.

In addition to the optional polymer, the organic/inorganic coating layer includes at least one optional metal selected from the group consisting of alkali metals, alkaline-earth metals and rare-earth elements. As for the alkali metal, Li is desirable especially. As for the alkali-earth metal, Mg is desirable especially. As for the rare-earth element, La is desirable especially. A preferable content of the optional metal in the organic/inorganic coating layer falls in a range of from 0.1 to 90% by mass, and an especially desirable content thereof falls in a range of from 1 to 50% by mass. When the content of the optional metal is less than 0.1% by mass, the advantages resulting from containing the optional metal are not caused to take effect; whereas, when the content exceeds 90% by mass, such a case arises probably as forming a uniform coating layer becomes difficult.

To form the organic/inorganic coating layer, using CVD methods or PVD methods, and the like, is feasible. However, the methods are not said to be preferable in view of costs, and the methods do not make including metallic elements easy, either. Hence, in a production process according to the present invention, the organic/inorganic coating layer is formed by applying a mixed solution comprising the optional polymer and a compound of the optional metal dissolved in a solvent onto the positive-electrode active-material layer and then drying the mixed solution thereon. As for the compound of the optional metal, the compound is not restricted especially as far as being compounds dissolving in the solvent, and accordingly nitrates, acetates, and the like, of the compound are usable.

Moreover, as for the solvent of the mixed solution, an organic solvent being capable of dissolving both of the optional polymer and optional-metal compound, or water is usable. To the organic solvent, any restrictions are not at all imposed especially, and even a mixture of multiple solvents does not matter at all. For example, the following are usable: alcohols, such as methanol, ethanol and propanol; ketones, such as acetone, methyl ethyl ketone and methyl isobutyl ketone; esters, such as ethyl acetate and butyl acetate; aromatic hydrocarbons, such as benzene and toluene; DMF; N-methyl-2-pyrrolidone; mixed solvents of N-methyl-2-pyrrolidone and an ester-based solvent (such as ethyl acetate, n-butyl acetate, butyl cellosolve acetate, or butyl carbitol acetate) or a glyme-based solvent (such as diglyme, triglyme, or tetraglyme). A desirable organic solvent is an organic solvent of which the boiling point is so low as to be readily removed from the organic/inorganic coating layer.

In applying the mixed solution, although applying the mixed solution with a spray, roller or brush, and the like, is allowable, the mixed solution is applied desirably by a dipping method onto the surface of a positive-electrode active material. When the mixed solution is applied by a dipping method, since voids or gaps between the positive-electrode active-material particles are impregnated with the mixed solution, the organic/inorganic coating layer is formable onto almost all the entire surface of the positive-electrode active-material particles. Therefore, the organic/inorganic coating layer enables the positive-electrode active material and an electrolytic solution to be securely prevented from contacting directly with each other.

Two methods are available as the method of applying the mixed solution by the dipping method. First of all, a slurry including the positive-electrode active material and a binder at least is bound together onto a current collector to form a positive-electrode precursor, and the positive-electrode precursor is immersed into the mixed solution and is then taken up therefrom to dry. The operations are repeated, if needed, thereby forming the organic/inorganic coating layer with a predetermined thickness.

When using the dipping method described above, immersing the positive-electrode precursor into the mixed solution for 2 minutes or more is preferable. Moreover, the immersion under a depressurized atmosphere is also preferable. By doing thusly, the interior of the positive-electrode active-material layer is fully impregnated with the mixed solution, thereby enabling the organic/inorganic coating layer to be formed onto a surface of the positive-electrode active material more securely.

As another method, a powder of the positive-electrode active material is first admixed with the mixed solution, and then the admixture is dried by a freeze-drying method, and the like. The operations are repeated, if needed, thereby forming the organic/inorganic coating layer with a predetermined thickness. Thereafter, a positive electrode is formed using the positive-electrode active material with the organic/inorganic coating layer formed.

After the dipping operation, washing the positive-electrode active-material layer with a proper solvent is preferable. When the washing is done insufficiently, the initial resistance of a positive electrode has risen because residuals at the time of coating occur on the surface of a positive electrode, or the capacity thereof declines when being used cyclically. The raised initial resistance and declined capacity are believed to occur because the residuals flow out into an electrolytic solution. Moreover, carrying out a heat treatment to the organic/inorganic coating layer formed by the dipping method is desirable. A heat-treatment temperature is possible to set at from 80 to 140° C., and a heat-treatment time is possible to set for from 10 minutes to three days. Moreover, a desirable heat-treatment atmosphere is a vacuum atmosphere, or a nonoxidizing-gas atmosphere.

A preferable thickness of the organic/inorganic coating layer falls in a range of from 0.1 nm to 100 nm, a more preferable thickness thereof falls in a range of from 0.1 nm to 10 nm, and an especially desirable thickness thereof falls in a range of from 0.1 nm to 5 nm. When a thickness of the organic/inorganic coating layer is too thin, such a case probably arises as the positive-electrode active material contacts directly with an electrolytic solution. Moreover, a thickness of the organic/inorganic coating layer is on an order of micrometers or more, the ion-conducting property declines because the resistance becomes large when the organic/inorganic coating layer makes up a secondary battery. To form such a thin organic/inorganic coating layer, the concentrations of the optional polymer and optional metal are kept low in the aforementioned dipping solution (i.e., the mixed solution), and then the dipping solution is applied repeatedly, thereby enabling a thin and uniform organic/inorganic coating layer to be formed.

Although an allowable organic/inorganic coating layer covers at least parts of surface of the positive-electrode active-material particles, a preferable organic/inorganic coating layer covers almost all faces of the positive-electrode active-material particles in order to prevent the positive-electrode active-material particles from contacting directly with an electrolytic solution.

A preferable concentration of the optional polymer is set at 0.001% by mass or more and less than 5.0% by mass in the mixed solution, and a desirable concentration thereof is set to fall in a range of from 0.1% by mass to 1.0% by mass therein. Within the range, the higher the concentration is, the more a post-cyclability-examination maintained capacity rate upgrades and the more a resistance is inhibited from rising. Moreover, when the mixed solution with the concentration falling in the range is applied, the organic/inorganic coating layer comes to have a thickness falling in a range of from 0.2 nm to 4 nm. When the concentration is so low as to deviate from the range, a long time comes to be needed for the coating operation because the contact probability is low between the optional polymer and the positive-electrode active material; whereas, when the concentration is too high, such a case probably arises as electrochemical reactions have been hindered on a positive electrode.

Inside the organic/inorganic coating layer, further including a lithium compound exhibiting a higher oxidation-reaction potential than does a carbonate-based electrolytic solution is also preferable. The phrase, “further including a lithium compound exhibiting a higher oxidation-reaction potential than does a carbonate-based electrolytic solution,” designates involving a lithium compound exhibiting a higher oxidation-oxidation potential than does a carbonate-based electrolytic solution therein. Further including such a lithium compound leads to further upgrading the property of voltage resistance, and accordingly to upgrading the cyclability of a lithium-ion secondary battery. Note herein that the term, “oxidation-reaction potential,” means a potential at which an oxidation reaction begins, that is, an onset voltage of decomposition. Such an oxidation-reaction potential shows different values depending on types of organic solvents in electrolytic solutions used for lithium-ion secondary batteries. In the present invention, the term, “oxidation-reaction potential,” is meant to be a value expressed when an oxidation-reaction potential is measured using a carbonate-based solvent as an organic solvent in an electrolytic solution.

As for a lithium compound exhibiting a higher oxidation-reaction potential than does a carbonate-based electrolytic solution, the following are exemplified: lithium bis(pentafluoroethylsulfonyl)imide (or LiBETI), lithium bis(trifluoromethylsulfonyl)imide (or LiTFSI), LiBF₄, LiCF₃SO₃, and the like. A preferable content of the lithium compound in the organic/inorganic coating layer falls in a range of from 10 to 80% by mass, and an especially preferable content thereof falls in a range of from 40 to 60% by mass. When a content of the lithium compound is less than 10% by mass, the advantages resulting from containing the lithium compound are not caused to take effect; whereas, when the content exceeds 80% by mass, such a case arises probably as forming a uniform coating layer involving the lithium compound therein becomes difficult.

Including the aforementioned lithium compound in the organic/inorganic coating layer is enabled to be readily carried out by the following operations, for instance: immersing an electrode with the organic/inorganic coating layer formed into a solution comprising the aforementioned lithium compound dissolved in a solvent, and then taking up the electrode therefrom to dry.

Forming a second organic coating layer onto a surface of the organic/inorganic coating layer is also preferable. The second organic coating layer enables the positive-electrode active-material particles to be further inhibited from contacting directly with an electrolytic solution at the time of a high-voltage driving mode or operation. However, when a summed layer thickness of the organic/inorganic coating layer and second organic coating layer becomes large, resistance against the property of lithium-ion conduction has augmented. Hence, as a polymer included in the second organic coating layer, using the following polymer is preferable: a polymer exhibiting a zeta potential being opposite in the positivity and negativity to a zeta potential of a polymer constituting the underlaying organic/inorganic coating layer. By thus setting the polymers, both of the underlaying organic/inorganic coating layer and second organic coating layer are formable as a thin film, respectively, and a total thickness of the coating layer comprising the organic/inorganic coating layer and the second organic coating layer is possible to set on the order of nanometers, because the underlaying organic/inorganic coating layer and the second organic layer are joined firmly one another by the coulomb force therebetween.

Note that, when a second organic coating layer is formed, a preferable total thickness of the coating layer comprising the organic/inorganic coating layer and the second organic coating layer falls in a range of from 0.1 nm to 100 nm, a more preferable total thickness thereof falls in a range of from 0.1 nm to 10 nm, and an especially desirable total thickness thereof falls in a range of from 0.1 nm to 5 nm. Moreover, an allowable second organic coating layer also includes the above-described optional metal and/or a lithium compound exhibiting a higher oxidation-reaction potential than does a carbonate-based electrolytic solution. In the case, the optional metal and/or the lithium compound included in the second organic coating layer are also allowed to be identical with the optional metal and/or the lithium compound included in the organic/inorganic coating layer, or even permitted to be distinct therefrom. Addition amounts of the optional metal and/or the lithium compound in the second organic coating layer are the same as the addition amounts in the instance of the organic/inorganic coating layer.

When dispersing the positive-electrode active-material particles (mainly indicating here in lithium transition metal oxides) used for the positive electrode according to the present invention in water or an organic solvent in such a state as no electrolyte is put therein to measure the zeta potential, the zeta potential has been revealed to be negative. From the phenomenon, using a cationic polymer of which the zeta potential is positive, such as polyethyleneimine, for instance, for the organic/inorganic coating layer is preferable. The thus set cationic polymer results in firmly joining the positive-electrode active material and the polymer one another by the Coulomb force therebetween. And, a preferable second organic coating layer is formed using an anionic polymer, such as a polyacrylic acid, of which the zeta potential is negative.

Note that the “zeta potential” referred to in the present invention is a zeta potential measured by a microscope electrophoretic method, a rotary diffraction grating method, a laser Doppler electrophoretic method, an ultrasonic vibration potential (or UVP) method, or an electrodynamic acoustic (or ESA) method. An especially preferable zeta potential is a zeta potential measured by the laser Doppler electrophoretic method. (Specific measurement conditions are explained below, but are not limited to the following. First of all, DMF, acetone or water was set as a solvent, and then a solution (or a suspension liquid) with a solid-content concentration of 0.1% by weight was prepared. The measurement of a zeta potential of the solution was carried out three times at 25° C. The zeta potential was found by computing the average value. Moreover, regarding a pH of the solution, the pH was set under the neutral condition.)

Since the thus formed organic/inorganic coating layer has high joining strength to the positive-electrode active material, the organic/inorganic coating layer enables the positive-electrode active material to be inhibited from contacting directly with an electrolytic solution at the time of a high-voltage driving mode or operation. Moreover, when a total thickness of the coating layer comprising the organic/inorganic coating layer and the second organic coating layer is on the order of nanometers, the total thickness also leads to enabling the coating layer to be inhibited from turning into resistance against the property of lithium-ion conduction. Therefore, inhibiting an electrolytic solution from decomposing is possible even when being driven with a high voltage, thereby making a lithium-ion secondary battery providable, the lithium-ion secondary battery not only being of high capacity but also being capable of maintaining high battery characteristics even after repetitive charging and discharging modes or operations.

As for a binder constituting the binding portion included in the positive-electrode active-material layer, the following are exemplified: polyvinylidene fluoride (e.g., polyvinylidene fluoride (e.g., PVdF)), polytetrafluoroethylene (or PTFE), styrene-butadiene rubber (or SBR), polyimide (or PI), polyamide-imide (or PAI), carboxymethyl cellulose (or CMC), polyvinylchloride (or PVC), methacrylic resins (or PMA), polyacrylonitrile (or PAN), modified polyphenylene oxide (or PPO), polyethylene oxide (or PEO), polyethylene (or PE), polypropylene (or PP), and the like. To the extent of not impairing the characteristics as a binder for positive electrode, blending one of the following, or combining two or more of the following to blend is also allowable: curing agents (such as epoxy resins, melamine resins, polyblock isocyanate, polyoxyazoline and polycarbodiimide); and various additives (such as ethylene glycol, glycerin, polyether polyol, polyester polyol, acrylic oligomers, phthalate esters, dimeric-acid modified substances, and polybutadiene-based compounds).

A desirable optional polymer constituting the organic/inorganic coating layer is a polymer exhibiting a satisfactory covering property to the binding portion. Therefore, using a polymer exhibiting a zeta potential being opposite in the positivity and negativity to a zeta potential of the binder is preferable. For example, when polyvinylidene fluoride (e.g., PVdF) is used for the binder, using a cationic optional polymer is preferable, because the polyvinylidene fluoride (e.g., PVdF) exhibits a negative zeta potential.

Moreover, the larger a potential difference between the binder and the optional polymer is, the more preferable the combination is. Therefore, when polyvinylidene fluoride (e.g., PVdF) is used for the binder, the following setting is preferable: using polyethyleneimine (or PEI) being likely to be cationized for the organic/inorganic coating layer; and selecting a solvent so as to make a zeta potential +20 mV or more.

Moreover, including a conductive additive in the positive-electrode active-material layer is also preferable. The conductive additive is added in order to enhance the electrically-conducting property of an electrode. As the conductive additive, the following are addable independently, or two or more of the following are combinable to add: carbonaceous fine particles, such as carbon black, graphite, and acetylene black (or AB); and gas-phase-method carbon fibers (or vapor-grown carbon fibers (or VGCF)). Although an employment amount of the conductive additive is not at all restrictive especially, setting the employment amount is possible at from 2 to 100 parts by mass approximately with respect to 100-part-by-mass active materials, for instance. When an amount of the conductive additive is less than 2 parts by mass, conductive passes with good efficiency are not formable; whereas, when the amount exceeds 100 pars by mass, not only the formability of an electrode worsens but also the energy density thereof becomes low.

A lithium-ion secondary battery according to the present invention comprises the present positive electrode. For a negative electrode and electrolytic solution, publicly-known negative electrodes and electrolytic solutions are usable. The negative electrode comprises a current collector, and a negative-elect rode active-material layer bound together onto the current collector. The negative-electrode active-material layer includes a negative-electrode active material, and a binder at least; but the negative-electrode active-material layer further including a conductive additive is also allowable. As for the negative-electrode active material, publicly-known negative-electrode active materials, such as graphite, hard carbon, silicon, carbon fibers, tin (Sn) and silicon oxide, are usable. Among the options, when a negative-electrode active material composed of carbon, such as graphite or hard carbon, is used, a resistance thereof after being used cyclically declines greatly, and thereby such a peculiar advantage as outputs upgrade being used cyclically is caused to take effect.

Moreover, as the negative-electrode active material, a silicon oxide expressed by SiOₓ (where 0.3≦“x”≦1.6) is also usable. Each of particles in a powder of the silicon oxide is composed of SiOₓ having been decomposed into fine Si, and SiO₂ covering the Si by a disproportionation reaction. When the “x” is less than the lower-limit value, volumetric changes become too large at the time of charging and discharging modes or operations because the Si ratio becomes so high, and thereby cyclability declines. Moreover, when the “x” exceeds the upper-limit value, the Si ratio declines so that energy density comes to decline. A preferable range is 0.5≦“x”≦1.5, and a more desirable range is 0.7≦“x”≦1.2.

In general, when being put under such a condition that oxygen is cut off, almost all of SiO has been said to separate into two phases at 800° C. or more. To be concrete, a silicon-oxide powder, which includes two phases, namely, a noncrystalline SiO₂ and a crystalline Si phase, is obtainable by carrying out to a raw-material silicon-oxide powder including a noncrystalline SiO powder a heat treatment at from 800 to 1,200° C. for from 1 to 5 hours in an inert atmosphere, such as in a vacuum or in an inert gas.

Moreover, as the silicon oxide, a composite is usable, composite in which a carbon material is composited with the SiOₓ in an amount of from 1 to 50% by mass. Compositing a carbon material upgrades cyclability. When a composited amount of the carbon material is less than 1% by mass, the advantageous effect of upgrading conductivity is not obtainable; whereas, when the composited amount exceeds 50% by mass, a proportion of the SiOₓ decreases relatively so that the capacity of a negative electrode has declined. A preferable composited amount of the carbon material falls in a range of from 5 to 30% by mass to the SiOₓ, and a more desirable composite amount thereof falls in a range of from 5 to 20% by mass thereto. A CVD method, or the like, is utilizable to composite the carbon material with the SiOₓ.

A desirable silicon-oxide powder has an average particle diameter falling in a range of from 1 μm to 10 μm. When the average particle diameter is larger than 10 μm, the charging and discharging characteristics of a nonaqueous-system secondary battery decline; whereas, when the average particle diameter is smaller than 1 μm, such a case arises probably that the charging and discharging characteristics of a nonaqueous-system secondary battery decline similarly because the powder agglomerates to become coarse particles.

For a current collector, binder and conductive additive in the negative electrode, the same current collector, binder and conductive additive as the current collector, binder and conductive additive used in the positive-electrode active-material layer are usable.

In the lithium-ion secondary battery according to the present invention using the above-mentioned positive electrode and negative electrode, publicly-known electrolytic solutions and separators are usable without any special limitations at all. An electrolytic solution is a solution in which a lithium metallic salt, namely, an electrolyte, has been dissolved in an organic solvent. The electrolytic solution is not at all limited especially. As the organic solvent, an aprotic organic solvent is usable. For example, at least one member selected from the group consisting of the following is usable for the organic solvent: propylene carbonate (or PC), ethylene carbonate (or EC), dimethyl carbonate (or DMC), diethyl carbonate (or DEC), ethyl methyl carbonate (or EMC), fluoroethylene carbonate (or FEC), and the like. Including fluoroethylene carbonate (or FEC) at least is desirable. Moreover, as for an electrolyte to be dissolved, a lithium metallic salt, such as LiPF₆, LiBF₄, LiAsF₆, LiI, LiClO₄ or LiCF₃SO₃, being soluble in the organic solvent is usable.

For example, the following solution is employable: a solution comprising a lithium metallic salt, such as LiClO₄, LiPF₆, LiBF₄ or LiCF₃SO₃, dissolved in a concentration of from 0.5 mol/L to 1.7 mol/L approximately in an organic solvent, such as ethylene carbonate, dimethyl carbonate, propylene carbonate or diethyl carbonate. Among the lithium metallic salts, using LiBF₄ is desirable. Since not only using the positive electrode with the organic/inorganic coating layer but also including LiBF₄ in the electrolytic solution result in making such an advantageous effect as the electrolyte becomes less likely to be decomposed obtainable synergistically, much higher battery characteristics are maintainable even after being charged and discharged repetitively in a high-voltage driving mode or operation.

The separator is one of the constituent elements isolating the positive electrode and negative electrode from one another and retaining the electrolytic solution therein, and accordingly a thin microporous membrane, such as polypropylene or polyethylene, is usable. Moreover, providing the microporous membrane with a heat-resistant layer of which the major component is an inorganic substance is also allowable. As for the inorganic substance to be used, aluminum oxide, or titanium oxide is preferable.

A lithium-ion secondary battery according to the present invention is not at all limited especially in the configuration, and accordingly various configurations, such as cylindrical types, rectangular types and coin types, are adoptable. Even when any one of the configurations is adopted, the separators are interposed or held between the positive electrodes and the negative electrodes to make electrode assemblies. Then, after connecting intervals from the positive-electrode current collectors and negative-electrode current collectors up to the positive-electrode terminals and negative-electrode terminals, which lead to the outside, with leads, and the like, for collecting electricity, the electrode assemblies are sealed hermetically in a battery case along with the electrolytic solution, thereby turning the positive-electrode and negative-electrode assemblies into a battery.

Note that the lithium-ion secondary battery according to the present invention is desirably subjected initially to an aging treatment in which the present lithium-ion secondary battery is retained at a high temperature in such a state as being charged up to an employment voltage. The aging treatment thus carried out enables the initial capacity to be inhibited from declining, and enables the initial resistance to be inhibited from augmenting. As for the employment voltage, 4.3 V or more is desirable, and 4.5 V is especially desirable. As for the heat-treatment conditions, the present lithium-ion secondary battery is retained allowably at a temperature of from 35° C. to 90° C. for from one hour to 240 hours.

The embodiment modes of the present invention are hereinafter explained in more detail while giving examples thereof.

### First Example

### Making of Positive Electrode

A mixed slurry including LiNi_{0.5}CO_{0.2}Mn_{0.3}O₂ serving as a positive-electrode active material in an amount of 94 parts by mass, acetylene black (or AB) serving as a conductive additive in an amount of 3 parts by mass and polyvinylidene fluoride (or PVdF) serving as a binder in an amount of 3 parts by mass was applied onto the surface of an aluminum foil (i.e., a current collector) using a doctor blade, and was then dried to form a positive-electrode active-material layer with a thickness of about 40 μm.

Lanthanum nitrate was dissolved in ethyl alcohol so as to make a concentration of 2.5 millimol/L, and then polyethyleneimine (or PEI) was further dissolved therein so as to make a concentration of 1% by mass, thereby preparing a mixed solution. After immersing the aforementioned positive-electrode precursor into the mixed solution at 25° C. for 10 minutes, the positive-electrode precursor was washed with ethanol and was then immersed into an ethanol solution in which a polyacrylic acid had been dissolved in an amount of 0.2% by mass. A series of the operations were repeated twice, and then the positive-electrode precursor was vacuum dried at 120° C. for 12 hours to obtain a positive electrode. In the positive electrode, a first organic/inorganic coating layer, and a second organic coating layer were formed. Hereinafter, the first organic/inorganic coating layer and second organic coating layer are sometimes simply referred to as a coating layer as a whole.

Note that the positive electrode, which had been taken from out of the ethanol solution to air dry, was thereafter vacuum dried at 120° C. for 12 hours to obtain a positive electrode with the coating layer.

Note that, when the lanthanum nitrate was first dissolved in the ethyl alcohol and subsequently the polyethyleneimine (or PEI) was dissolved therein in preparing the aforementioned mixed solution, the solution became transparent after the solution had become clouded instantaneously. When the mixed solution was analyzed using a grain-size distribution measuring instrument (e.g., “NANO ANALYZER SZ-100” produced by HORIBA Corporation), fine particles with particles diameters falling in an extremely narrow range of 2 nm±0.3 nm were found out to exist. Since no such a sharp grain-size distribution occurs in the fine particles of an inorganic substance, the fine particles are inferred to be fine particles in which lanthanum ions were coordinated to polyethyleneimine.

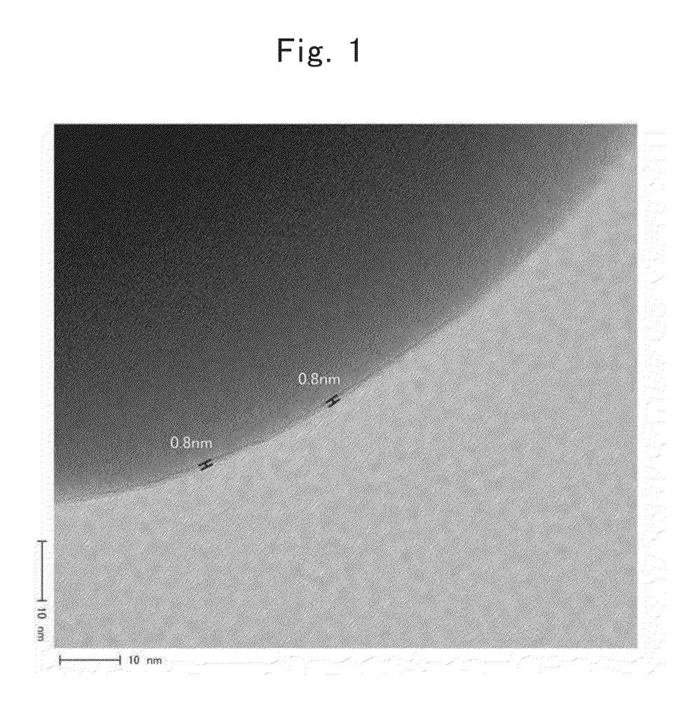

FIG. 1 shows a TEM image of the positive electrode measured with an acceleration voltage of 200 kV and at a magnification of 2.05 million times, using a transmission electron microscope (“H9000NAR” produced by HITACHI HIGH TECHNOLOGIES Corporation). In FIG. 1, a coating layer with a thickness of about 0.8 nm is observed to cover a positive-electrode active-material particle. Note that the above-described particle diameters, 2 nm±0.3 nm, were the particle diameters of polymers swollen by the solvent; whereas about 0.8 nm, the thickness of the coating layer, was the post-drying thickness.

### Making of Negative Electrode

First of all, an SiO powder produced by Sigma Aldrich Japan Corporation and exhibiting an average particle diameter of 5 μm was heat treated at 900° C. for two hours, and thereby an SiOₓ powder with an average particle diameter of 5 μm was prepared. Note that, when SiO is homogenous, solid silicon monoxide (SiO) of which the ratio between Si and O is 1:1 roughly, the heat treatment leads to decomposing the SiO into two phases, an Si phase and an SiO₂ phase, by the internal reactions of solid. The Si phase obtained by separation is very fine.

A slurry was prepared by mixing the following one another: the SiOₓ powder in an amount of 32 parts by mass; natural graphite in an amount of 50 parts by mass; acetylene black (or AB) serving as a conductive additive in an amount of 8 parts by mass; and polyamide-imide serving as a binding agent in an amount of 10 parts by mass. The slurry was applied onto the surface of a 18-μm-thickness electrolyzed copper foil (i.e., a current collector) using a doctor blade, and thereby a negative electrode with a negative-electrode active-material layer in a thickness of about 15 μm on the copper foil was obtained.

### Fabricating of Lithium-Ion Secondary Battery

For a nonaqueous electrolytic solution, the following electrolytic solution was used: an electrolytic solution comprising: a mixed solvent composed of fluoroethylene carbonate (or FEC), ethylene carbonate (or EC), methyl ethyl carbonate (MEC) and dimethyl carbonate (or DMC) mixed one another in a ratio of 4:26:30:40 by volumetric percentage; and LiPF₆ and LPFO (of which the compositional formula was LiPF₂(C₂O₄)₂) dissolved in the mixed solvent in a concentration of 1 mole and 0.01 mole, respectively.

And, between the above-mentioned positive electrode and negative electrode, a microporous polypropylene/polyethylene/polypropylene laminated film with a thickness of 20 μm was interposed or held as a separator to make an electrode assembly. The electrode assembly was wrapped up with a laminate film made of polypropylene, and was then heat welded around the periphery to fabricate a film-pouched battery. Before heat welding the last side to seal, the above-mentioned nonaqueous electrolytic solution was injected into the film-pouched battery to impregnate the electrode assembly with the nonaqueous electrolytic solution, thereby fabricating a lithium-ion secondary battery according to the present example.

### First Comparative Example

A positive electrode, which was the same as the positive electrode in the first example but on which the coating layer was not formed, was used. Other than using the positive electrode, a lithium-ion secondary battery was fabricated in the same manner as the first example.

### Second Comparative Example

A mixed solution, which was the same as the mixed solution in the first example but to which the lanthanum nitrate was not added, was used to make a positive electrode. Other than using the positive electrode, a lithium-ion secondary battery was fabricated in the same manner as the first example.

### First Testing Example

Using the lithium-ion secondary batteries according to the first example and the first and second comparative examples, initial first-round-discharge IR drops were measured. In measuring the first-round-discharge IR drops, resistance values of the positive electrodes were measured, respectively, as follows. Under such conditions that the measurement temperature was 25° C. and a CCCV charging (i.e., constant-current and constant-voltage charging) mode was carried out at 1C, the batteries were charged up to a battery voltage of 4.5 V, and were then retained at the voltage for 2.5 hours. Thereafter, the batteries were discharged in a CC discharging (i.e., constant-current discharging) mode carried out at 0.33C. The resistance values of the positive electrodes were positive-electrode resistance values measured 10 seconds later after the discharging mode had started.

Next, using the lithium-ion secondary batteries according to the first example and the first and second comparative examples, a cycle test was carried out. In the cycle test, a cycle composed of steps described below was repeated 100 cycles: the batteries were charged up to a battery voltage of 4.5 V under such conditions that the temperature was set at 25° C. and a CC charging mode was carried out at 1C; the batteries took a pause for 10 minutes after the charging mode; the batteries were then discharged at 3.0 V in a CC discharging mode carried out at 1C; and the batteries took another pause for another 10 minutes after the discharging mode. Then, using the respective lithium-ion secondary batteries undergone the cycle test, post-cycle-test first-round-discharge IR drops were measured in the same manner as the initial first-round-discharge IR drops were measured. Table 1 shows the results.

TABLE 1

| | Discharge IR Drop (Ω) | | |
|---|---|---|---|
| | | First | Second |
| | | Comparative | Comparative |
| | First Example | Example | Example |
| Coating Layer | (PEI + La) + PAA | — | PEI + PAA |
| Initial | 12.5 | 11.0 | 13.3 |
| Post-100-Cylce | 14.6 | 23.8 | 20.4 |

The lithium-ion secondary battery according to the first example had a slight rise in the resistance even after 100 cycles, compared with the first and second comparative examples. The slight rise is an apparent advantageous effect evidently resulting from including lanthanum in the organic/inorganic coating layer.

### Second Testing Example

Using the lithium-ion secondary batteries according to the first example and the first and second comparative examples, a cycle test was carried out to the batteries, respectively. In the cycle test, a cycle composed of steps described below was repeated 200 cycles: the batteries were charged up to a 4.32 V under such conditions that the temperature was set at 60° C. and a CC charging mode was carried out at 1C; the batteries took a pause for 10 minutes after the charging mode; the batteries were then discharged at 3.26V in a CC discharging mode carried out at 1C; and the batteries took another pause for another 10 minutes after the discharging mode. The batteries were measured for discharged-capacity maintained ratios at the 100th cycle and 200th cycle, respectively. Table 2 shows the results. Note that the “discharged-capacity maintained ratio” is a value found by a percentage value which is obtained by dividing an “N”th-cycle discharged capacity by a first-round discharged capacity (i.e., {(“N”th-cycle Discharged Capacity)/(First-round Discharged Capacity)}×100).

TABLE 2

| | Capacity Maintained Ratio (%) | | | | |
|---|---|---|---|---|---|
| | | | First | | Second |
| | | | Comparative | | Comparative |
| | First Example | | Example | | Example |
| Coating | (PEI + La) + PAA | | — | | PEI + PAA |
| Layer | | | | | |
| Number of | n = 1 | n = 2 | n = 1 | n = 2 | n = 1 |
| Cycles | | | | | |
| 100 | 88.7 | 86.5 | 81.0 | 79.6 | 83.0 |
| 200 | 83.6 | 80.8 | 71.8 | 71.7 | 73.5 |

Moreover, 20%-SOC (i.e., state-of-charge) discharge resistances were measured at 50° C. during the 100th cycle and 200th cycle, respectively, thereby finding resistance raised ratios. Table 3 shows the results. Note that the “resistance raised ratio” is a value found by a percentage value which is obtained by dividing a subtracted value, which has been found by subtracting a first-round discharge resistance from an “N”th-cycle discharge resistance, by the first-round discharge resistance (i.e., [{(“N”th-cycle Discharge Resistance) (First-round Discharge Resistance)}/(First-round Discharged Resistance)]×100).

TABLE 3

| | Resistance Raised Ratio (%) | | | | |
|---|---|---|---|---|---|
| | | | First | | Second |
| | | | Comparative | | Comparative |
| | First Example | | Example | | Example |
| Coating | (PEI + La) + PAA | | — | | PEI + PAA |
| Layer | | | | | |
| Number of | n = 1 | n = 2 | n = 1 | n = 2 | n = 1 |
| Cycles | | | | | |
| 100 | 0.2 | 6.2 | 57.4 | 53.9 | 54.8 |
| 200 | 12.1 | 16.9 | 100.2 | 79.6 | 80.8 |

The lithium-ion secondary battery according to the second comparative example had a high discharged-capacity maintained ratio and a low resistance raised ratio, compared with the first comparative example. The higher discharged-capacity maintained ratio, and the lower resistance raised ratio are advantageous effects resulting from forming the coating layer composed of polyethyleneimine and polyacrylic acid. However, the lithium-ion secondary battery according to the first example had a high discharged-capacity maintained ratio and a low resistance raised ratio, even compared with the second comparative example. The much higher discharged-capacity maintained ratio, and the much lower resistance raised ratio are apparent advantageous effects evidently resulting from including lanthanum in the organic/inorganic coating layer.

### Second Example

### Making of Positive Electrode

A mixed slurry including LiNi_{0.5}Co_{0.2}Mn_{0.3}O₂ serving as a positive-electrode active material in an amount of 94 parts by mass, acetylene black (or AB) serving as a conductive additive in an amount of 3 parts by mass and polyvinylidene fluoride (or PVdF) serving as a binder in an amount of 3 parts by mass was applied onto the surface of an aluminum foil (i.e., a current collector) using a doctor blade, and was then dried to form a positive-electrode active-material layer with a thickness of about 40 μm.

Magnesium nitrate was dissolved in ethyl alcohol so as to make a concentration of 2.5 millimol/L, and then polyethyleneimine (or PEI) was further dissolved therein so as to make a concentration of 1% by mass, thereby preparing a mixed solution. After immersing the aforementioned positive-electrode precursor into the mixed solution at 25° C. for 10 minutes, the positive-electrode precursor was taken from out of the mixed solution to air dry. Thereafter, the positive-electrode precursor was vacuum dried at 120° C. for 12 hours to obtain a positive electrode with an organic/inorganic coating layer.

### Fabricating of Lithium-Ion Secondary Battery

Other than using the positive electrode, a lithium-ion secondary battery was fabricated in the same manner as the first example.

### Third Testing Example

To the lithium-ion secondary batteries according to the second example and the first and second comparative examples, the same cycle test as described in the first testing example was carried out. Prior-to-cycle-test (or initial) and post-100-cycle impedance characteristics were evaluated. To be concrete, a frequency was changed from 0.1 Hz to 1,000,000 Hz at a temperature of 25° C. and at a voltage of 3.51 V, the absolute vale of a resistance (i.e.,) at 0.1 Hz was labeled an impedance value. Table 4 shows the results.

TABLE 4

| | Absolute Value of Resistance (Ω) | | |
|---|---|---|---|
| | | First | Second |
| | | Comparative | Comparative |
| | Second Example | Example | Example |
| Coating Layer | (PEI + Mg) + PAA | — | PEI + PAA |
| Initial | 2.63 | 2.56 | 2.60 |
| After 100 Cycles | 2.75 | 8.40 | 6.31 |

### Fourth Testing Example

Using the lithium-ion secondary batteries according to the second example and the first and second comparative examples, the same test as described in the second testing example was carried out. Table 5, and Table 6 show the results of measuring the discharge-capacity maintained ratios, and the results of measuring the resistance raised ratios, respectively.

TABLE 5

| | Capacity Maintained Ratio (%) | | | |
|---|---|---|---|---|
| | | First | | Second |
| | | Comparative | | Comparative |
| | Second Example | Example | | Example |
| Coating | (PEI + Mg) + PAA | — | | PEI + PAA |
| Layer | | | | |
| Number of | n = 1 | n = 1 | n = 2 | n = 1 |
| Cycles | | | | |
| 100 | 80.7 | 81.0 | 79.6 | 83.0 |
| 200 | 72.7 | 71.8 | 71.7 | 73.5 |

TABLE 6

Resistance Raised Ratio (%)

| | | |
|---|---|---|
| | First | Second |
| | Comparative | Comparative |
| Second Example | Example | Example |

| | | | | |
|---|---|---|---|---|
| Number of | n = 1 | n = 1 | n = 2 | n = 1 |
| Cycles | | | | |
| 100 | 29.9 | 57.4 | 53.9 | 54.8 |
| 200 | 44.1 | 100.2 | 79.6 | 80.8 |

Regarding the discharged-capacity maintained ratio, all of the lithium-ion secondary batteries did not show any major difference one another, but the lithium-ion secondary battery according to the second example had a low resistance raised ratio, compared with the respective comparative examples. The lower resistance raised ratio is an apparent advantageous effect evidently resulting from including magnesium in the organic/inorganic coating layer.

### Third Example

A mixed slurry including LiNi_{0.5}Co_{0.2}Mn_{0.3}O₂ serving as a positive-electrode active material in an amount of 94 parts by mass, acetylene black (or AB) serving as a conductive additive in an amount of 3 parts by mass and polyvinylidene fluoride (or PVdF) serving as a binder in an amount of 3 parts by mass was applied onto the surface of an aluminum foil (i.e., a current collector) using a doctor blade, and was then dried to form a positive-electrode active-material layer with a thickness of about 40 μm.

Lithium acetate was dissolved in ethyl alcohol so as to make a concentration of 0.23 mol/L, and then polyethyleneimine (or PEI) was further dissolved therein so as to make a concentration of 1% by mass, thereby preparing a mixed solution. After immersing the aforementioned positive-electrode precursor into the mixed solution at 25° C. for 10 minutes, the positive-electrode precursor was washed with ethanol and was then immersed into an ethanol solution in which a polyacrylic acid had been dissolved in an amount of 0.2% by mass. A series of the operations were repeated twice, and then the positive-electrode precursor was vacuum dried at 120° C. for 12 hours to obtain a positive electrode. On the positive electrode, an organic/inorganic coating layer, and a second organic coating layer were formed.

### Fabricating of Lithium-Ion Secondary Battery

Other than using the positive electrode, a lithium-ion secondary battery was fabricated in the same manner as the first example.

### Fifth Testing Example

To the lithium-ion secondary batteries according to the third example and the first and second comparative examples, the same cycle test as described in the first testing example was carried out. Prior-to-cycle-test (or initial) and post-100-cycle discharged capacities were measured, and then capacity maintained ratios were calculated. The discharged capacities were measured when the batteries underwent the following steps: being charged up to a battery voltage of 4.5 V under such conditions that the temperature was set at 25° C. and a CCCV charging (i.e., constant-current and constant-voltage charging) mode was carried out at 0.2C; taking a pause for 10 minutes after the charging mode; and being discharged thereafter down to 3.0 V in a CC discharging (i.e., constant-current discharging) mode carried out at 0.33C. Table 7 shows the results.

TABLE 7

| | | First | Second |
|---|---|---|---|
| | | Comparative | Comparative |
| | Third Example | Example | Example |
| Coating Layer | (PEI + Li) + PAA | — | PEI + PAA |
| Initial | 141.8 | 143.8 | 143.3 |
| Capacity | | | |
| (mAh/g) at 0.33 C | | | |
| Capacity | 87.3 | 85.8 | 84.0 |
| Maintained | | | |
| Ratio (%) at | | | |
| 0.33 C | | | |

Table 7 represents that the lithium-ion secondary battery according to the second comparative example had a high capacity maintained ratio, compared with the first comparative example. The higher capacity maintained ratio is an advantageous effect resulting from forming a coating layer comprising the organic/inorganic coating layer and the second organic coating layer. However, the lithium-ion secondary battery according to the third example had a high capacity maintained ratio, even compared with the second comparative example. The much higher capacity maintained ratio is an apparent advantageous effect evidently resulting from including lithium in the organic/inorganic coating layer. Although the mechanism has not been cleared yet, lithium ions coordinating to polyethyleneimine and/or polyacrylic acid are inferred to lead to excluding adverse effects resulting from protons having been coordinated thereto originally.

### Sixth Testing Example

Using the lithium-ion secondary batteries according to the third example and the first and second comparative examples, the same test as described in the second testing example was carried out. Table 8, and Table 9 show the results of measuring the discharged-capacity maintained ratios, and the results of measuring the resistance raised ratios, respectively.

TABLE 8

| | Capacity Maintained Ratio (%) | | | | |
|---|---|---|---|---|---|
| | | | First | | Second |
| | | | Comparative | | Comparative |
| | Third Example | | Example | | Example |
| Coating | (PEI + Li) + PAA | | — | | PEI + PAA |
| Layer | | | | | |
| Number of | n = 1 | n = 2 | n = 1 | n = 2 | n = 1 |
| Cycles | | | | | |
| 100 | 85.5 | 85.6 | 81.0 | 79.6 | 83.0 |
| 200 | 76.9 | 77.6 | 71.8 | 71.7 | 73.5 |

TABLE 9

| | Resistance Raised Ratio (%) | | | | |
|---|---|---|---|---|---|
| | | | First | | Second |
| | | | Comparative | | Comparative |
| | Third Example | | Example | | Example |
| Coating | (PEI + Li) + PAA | | — | | PEI + PAA |
| Layer | | | | | |
| Number of | n = 1 | n = 2 | n = 1 | n = 2 | n = 1 |
| Cycles | | | | | |
| 100 | — | — | 57.4 | 53.9 | 54.8 |
| 200 | 43.2 | 43.6 | 100.2 | 79.6 | 80.8 |

Regarding the discharged-capacity maintained ratio, although the lithium-ion secondary battery according to the third example had a higher discharged-capacity maintained ratio than did the first and second comparative examples, the differences were not great at all. However, the lithium-ion secondary battery according to the third example had extremely low resistance raised ratios, compared with the respective comparative examples. The lower resistance raised ratios are an apparent advantageous effect evidently resulting from including lithium in the organic/inorganic coating layer.

### Fourth Example

In the same manner as the positive electrode according to the first example, an electrode with an organic/inorganic coating layer including lanthanum and a second organic coating layer composed of a polyacrylic acid was made. An ethanol solution comprising lithium bis(pentafluoroethylsulfonyl)imide (or LiBETI) dissolved therein in an amount of 0.04 mol/L was prepared. After immersing the electrode into the ethanol solution at 25° C. for 10 minutes, the electrode was taken from out of the ethanol solution and was then washed with ethanol, and was thereafter vacuum dried at 120° C. for 12 hours to obtain a positive electrode. The LiBETI content in the positive electrode was a quadrupled amount to the lanthanum content.

### Fabricating of Lithium-Ion Secondary Battery

Other than using the positive electrode, a lithium-ion secondary battery was fabricated in the same manner as the first example.

### Seventh Testing Example

The lithium-ion secondary batteries according to the fourth example, the first comparative example and the first example were measured for discharged capacities (or initial capacities) when the batteries underwent the following steps: being charged up to a battery voltage of 4.5 V under such conditions that the temperature was set at 25° C. and a CCCV charging mode (with a CCCV operation incorporated) was carried out at 1C for 2.5 hours; taking a pause for 10 minutes after the CCCV charging mode; and being discharged thereafter down to 2.5 V in a CCCV discharging mode (with a CCCV operation incorporated) carried out at 0.33C for 5 hours. Prior-to-cycle-test (or initial) and post-100-cycle discharged capacities were measured, and then capacity maintained ratios were calculated. Subsequently, the batteries were charged up to a battery voltage of 4.32 V under such conditions that the temperature was set at 25° C. and a CCCV charging mode (with a CCCV operation incorporated) was carried out at 1C for 2.5 hours, and were then retained within a 60° C. furnace for 12 days. Thereafter, discharged capacities after the preservation (or post-preservation capacities) were measured in the same manner as the initial capacities, and proportions of the post-preservation capacities to the initial capacities were calculated. Table 10 shows the results.

TABLE 10

| | | First | |
|---|---|---|---|
| | | Comparative | |
| | Fourth Example | Example | First Example |
| Coating Layer | (PEI + La) + PAA + | — | (PEI + La) + PAA |
| | LiBETI | | |
| Capacity | 86.6 | 84.0 | 84.3 |
| Maintained | | | |
| Ratio (%) | | | |

The lithium-ion secondary battery according to the fourth example had a high capacity maintained ratio, even compared with the first example. The higher capacity maintained ratio is an apparent advantageous effect evidently resulting from the coating layer including, in to lanthanum, lithium addition bis(pentafluoroethylsulfonyl)imide (or LiBETI). Although not having been cleared yet, the mechanism is inferred to be as follows. LiPF₆, an electrolyte, has been known to decompose during a 60° C.-preservation test carried out at a high voltage (e.g., with a battery voltage of 4.3 V or more). In the present example, LiBETI being superior in the voltage resistance coordinates to PEI, and then the resulting anions inhibit PF₆⁻ ions from approaching. Thus, LiPF₆ are believed to be inhibited from decomposing.

### Eighth Testing Example

Using the lithium-ion secondary batteries according to the fourth example and the first and second comparative examples, the same test as described in the second testing example was carried out. Table 11, and Table 12 show the results of measuring the discharged-capacity maintained ratios, and the results of measuring the resistance raised ratios, respectively.

TABLE 11

| | Capacity Maintained Ratio (%) | | | | |
|---|---|---|---|---|---|
| | | | First | | Second |
| | | | Comparative | | Comparative |
| | Fourth Example | | Example | | Example |
| Coating | (PEI + La) + PAA + | | — | | PEI + PAA |
| Layer | LiBETI | | | | |
| Number of | n = 1 | n = 2 | n = 1 | n = 2 | n = 1 |
| Cycles | | | | | |
| 100 | 85.6 | 85.0 | 81.0 | 79.6 | 83.0 |
| 200 | 79.6 | 78.2 | 71.8 | 71.7 | 73.5 |

TABLE 12

| | Resistance Raised Ratio (%) | | | | |
|---|---|---|---|---|---|
| | | | First | | Second |
| | | | Comparative | | Comparative |
| | Fourth Example | | Example | | Example |
| Coating | (PEI + La) + PAA + | | — | | PEI + PAA |
| Layer | LiBETI | | | | |
| Number of | n = 1 | n = 2 | n = 1 | n = 2 | n = 1 |
| Cycles | | | | | |
| 100 | 3.4 | 10.8 | 57.4 | 53.9 | 54.8 |
| 200 | 17.2 | 29.7 | 100.2 | 79.6 | 80.8 |

The lithium-ion secondary battery according to the second comparative example had high discharged-capacity maintained ratios, compared with the first comparative example. The higher discharged-capacity maintained ratios are an advantageous effect resulting from forming a coating layer composed of polyethyleneimine. However, the lithium-ion secondary battery according to the fourth example had high discharged-capacity maintained ratios and remarkably low resistance raised ratios, even compared with the second comparative example. The much higher discharged-capacity maintained ratios, and the much lower resistance raised ratios are apparent advantageous effects evidently resulting from including lanthanum and LiBETI in the organic/inorganic coating layer.

### Fifth Example

### Making of Positive Electrode

A mixed slurry including LiNi_{0.5}Co_{0.2}Mn_{0.3}O₂ serving as a positive-electrode active material in an amount of 94 parts by mass, acetylene black (or AB) serving as a conductive additive in an amount of 3 parts by mass and polyvinylidene fluoride (or PVdF) serving as a binder in an amount of 3 parts by mass was applied onto the surface of an aluminum foil (i.e., a current collector) using a doctor blade, and was then dried to form a positive-electrode active-material layer with a thickness of about 40 μm.

Lanthanum nitrate was dissolved in ethyl alcohol so as to make a concentration of 2.5 millimol/L, and then polyethyleneimine (or PEI) was further dissolved therein so as to make a concentration of 1% by mass, thereby preparing a mixed solution. After immersing the aforementioned positive-electrode precursor into the mixed solution at 25° C. for 10 minutes, the positive-electrode precursor was taken from out of the mixed solution and was then washed with ethanol. Finally, the positive-electrode precursor was vacuum dried at 120° C. for 12 hours to obtain a positive electrode.

### Making of Negative Electrode

A slurry was prepared by mixing the following one another: graphite in an amount of 97 parts by mass; a powder of acetylene black (or AB) serving as a conductive additive in an amount of 1 part by mass; and a binder comprising a mixture composed of styrene-butadiene rubber (or SBR) and carboxymethyl cellulose (or CMC) in a ratio of 1:1 by mass in an amount of 2 parts by mass. The slurry was applied onto the surface of a 18-μm-thickness electrolyzed copper foil (i.e., a current collector) using a doctor blade, thereby forming a negative-electrode active-material layer in a thickness of about 15 μm on the copper foil to obtain a negative electrode.

### Fabricating of Lithium-Ion Secondary Battery

For a nonaqueous electrolytic solution, the following electrolytic solution was used: an electrolytic solution comprising: a mixed solvent composed of fluoroethylene carbonate (or FEC), ethylene carbonate (or EC), methyl ethyl carbonate (MEC) and dimethyl carbonate (or DMC) mixed one another in a ratio of 4:26:30:40 by volumetric percentage; and LiPF₆ dissolved in the mixed solvent in a concentration of 1 mole.

And, using the aforementioned positive electrode and negative electrode, a lithium-ion secondary battery according to the present example was fabricated in the same manner as the first example.

### Sixth Example

### Making of Positive Electrode

A positive-electrode active-material layer was formed in the same manner as the fifth example. Next, lanthanum nitrate was dissolved in ethyl alcohol so as to make a concentration of 2.5 millimol/L, and then polyethyleneimine (or PEI) was further dissolved therein so as to make a concentration of 0.005% by mass, thereby preparing a mixed solution. After immersing a positive-electrode precursor with the positive-electrode active-material layer into the mixed solution at 25° C. for 10 minutes, the positive-electrode precursor was washed with ethanol and was then immersed into an ethanol solution in which a polyacrylic acid had been dissolved in an amount of 0.5% by mass. A series of the operations were repeated twice, and then the positive-electrode precursor was vacuum dried at 120° C. for 12 hours to obtain a positive electrode.

### Fabricating of Lithium-Ion Secondary Battery

Using the aforementioned positive electrode and the same negative electrode as the fifth example, a lithium-ion secondary battery according to the present example was fabricated in the same manner as the first example.

### Seventh Example

Other than using a mixed solution of which the polyethyleneimine (or PEI) concentration was 0.05% by mass, a positive electrode was made in the same manner as the sixth example. Using the positive electrode and the same negative electrode as the fifth example, a lithium-ion secondary battery according to the present example was fabricated in the same manner as the first example.

### Eighth Example

Other than using a mixed solution of which the polyethyleneimine (or PEI) concentration was 0.1% by mass, a positive electrode was made in the same manner as the sixth example. Using the positive electrode and the same negative electrode as the fifth example, a lithium-ion secondary battery according to the present example was fabricated in the same manner as the first example.

### Ninth Example

Other than using a mixed solution of which the polyethyleneimine (or PEI) concentration was 1.0% by mass, a positive electrode was made in the same manner as the sixth example. Using the positive electrode and the same negative electrode as the fifth example, a lithium-ion secondary battery according to the present example was fabricated in the same manner as the first example.

### Third Comparative Example

Except for not being provided with the coating layer, the same positive electrode as the sixth example was used. The other constituent elements were set in the same manner as the fifth example to fabricate a lithium-ion secondary battery.

### Ninth Testing Example

To each of the lithium-ion secondary batteries according to the fifth through ninth examples and the third comparative example, a cycle test was carried out. In the cycle test, a cycle composed of steps described below was repeated 200 cycles: the batteries were charged up to a battery voltage of 4.32 V under such conditions that the temperature was set at 60° C. and a CCCV charging mode was carried out at 1C; the batteries took a pause for 10 minutes after the charging mode; the batteries were then discharged at 3.26 V in a CC discharging mode carried out at 1C; and the batteries took another pause for another 10 minutes after the discharging mode. Prior-to-cycle-test (or initial) and post-200-cycle discharged capacities were measured, and then capacity maintained ratios were calculated. The discharged capacities were measured when the batteries underwent the following steps: being charged up to a battery voltage of 4.5 V under such conditions that the temperature was set at 25° C. and a CCCV charging (i.e., constant-current and constant-voltage charging) mode was carried out at 0.2C; taking a pause for 10 minutes after the charging mode; and being discharged thereafter down to 3.0 V in a CC discharging (i.e., constant-current discharging) mode carried out at 0.33C. Table 13 shows the results.

Moreover, the respective lithium-ion secondary batteries were measured for initial and post-200-cycle 10-second resistances, respectively, and the resistance raised ratios were calculated. Table 13 shows the results as well. Note that, in order to find the “10-second resistances,” the batteries were charged up to 20% SOC at 25° C., and were thereafter discharged for 10 seconds under a 3C condition to measure voltage drop magnitudes over the period. The measured voltage drop magnitudes were then used to calculate the 10-second resistances based on the following equation.

(10-second Resistance)=(Voltage Drop Magnitude over 10 Seconds)/(Current Value at 3C)

TABLE 13

| | | Capacity | |
|---|---|---|---|
| | | Maintained | Resistance |
| | Coating Layer | Ratio (%) | Raised Ratio (%) |
| Fifth Example | 1.0%-PEI + La | 90.4 | −9.39 |
| Sixth Example | 0.005%-PEI + La + | 87.0 | 23.73 |
| | PAA | | |
| Seventh Example | 0.05%-PEI + La + | 87.0 | 10.64 |
| | PAA | | |
| Eighth Example | 0.1%-PEI + La + | 87.9 | −6.87 |
| | PAA | | |
| Ninth Example | 1.0%-PEI + La + | 92.2 | −23.65 |
| | PAA | | |
| Third | — | 85.3 | 28.01 |
| Comparative | | | |
| Example | | | |

Even when graphite was used for the negative-electrode active material, comprising the organic/inorganic coating layer on the positive electrode apparently led to upgrading the post-cycle-test characteristics. Moreover, as the concentration of polyethyleneimine (or PEI) in the mixed solution became high, the following were found out: not only the capacity maintained ratio upgraded but also the resistance raised ratio declined. That is, using the mixed solution including polyethyleneimine (or PEI) in a concentration of 0.1% by mass or more to form the organic/inorganic coating layer leads to declining the post-cycle-test resistance greatly down to less than the initial resistance. The negative resistance raised ratios mean that carrying out the outputs of the batteries.

### Tenth Testing Example

Each of the lithium-ion secondary batteries according to the ninth example and the third comparative example was charged up to a battery voltage of 4.32 V under such conditions that the temperature was set at 60° C. and a CCCV charging mode was carried out at 1C, and was thereafter preserved at 60° C. for 12 days. Moreover, the prior-to-preservation and post-preservation lithium-ion secondary batteries were measured for discharged capacities in the same manner as the ninth testing example, and then the capacity maintained ratios were calculated. In addition, the resistance raised ratios were calculated in the same manner as the ninth testing example. Table 14 shows the respective results.

TABLE 14

| | | Capacity | |
|---|---|---|---|
| | | Maintained | Resistance |
| | Coating Layer | Ratio (%) | Raised Ratio (%) |
| Ninth Example | 1.0%-PEI + La + | 85.9 | 3.81 |
| | PAA | | |
| Third | — | 82.9 | 13.73 |
| Comparative | | | |
| Example | | | |

Even when graphite was used for the negative-electrode active material, comprising the organic/inorganic coating layer in the positive electrode apparently led to upgrading the post-preservation characteristics of the battery undergone the 60° C. preservation for 12 days.

### Tenth Example

A lithium-ion secondary battery was fabricated in the same manner as the ninth example. Then, the battery was first subjected to a conditioning treatment in which the battery was discharged initially at 25° C., thereby stabilizing the irreversible capacity. Next, the battery was subjected to an aging treatment in which the battery was charged up to a battery voltage of 4.32 V under such conditions that the temperature was set at 60° C. and a CCCV charging mode was carried out at 1C, and was thereafter retained at 60° C. for 12 hours.

### Eleventh Example

Other than not carrying out the aging treatment, a lithium-ion secondary battery according to an eleventh example was obtained in the same manner as the tenth example.

### Fourth Comparative Example

The same lithium-ion secondary battery as the third comparative example was used. Then, the same aging treatment as described in the tenth example was carried out.

### Eleventh Testing Example

The lithium-ion secondary batteries according to the tenth and eleventh examples as well as the third and fourth comparative examples were measured for discharged capacities when the batteries underwent the following steps: being charged up to a battery voltage of 4.5 V under such conditions that the temperature was set at 25° C. and a CCCV charging (i.e., constant-current and constant-voltage charging) mode was carried out at 0.2C; taking a pause for 10 minutes after the charging mode; and being discharged thereafter down to 3.0 V in a CC discharging (i.e., constant-current discharging) mode carried out at 0.33C. Table 15 shows the results as the initial capacities. Moreover, the 10-second resistances were measured in the same manner as described in the ninth testing example. Table 15 also shows the results as the initial resistances.

TABLE 15

| | | | Initial | Initial |
|---|---|---|---|---|
| | Coating | | Capacity | Resistance |
| | Layer | Aging | (mAh/g) | (Ω) |
| Tenth | 1.0%-PEI + La + | Done | 135.8 | 7.44 |
| Example | PAA | | | |
| Eleventh | 1.0%-PEI + La + | Not Done | 139.7 | 7.29 |
| Example | PAA | | | |
| Third | — | Not Done | 140.1 | 7.13 |
| Comparative | | | | |
| Example | | | | |
| Fourth | — | Done | 133.2 | 7.91 |
| Comparative | | | | |
| Example | | | | |

In general, although doing the aging treatment leads to upgrading the high-temperature preservation property and high-temperature cyclability, such problems have arisen as the initial capacity declines and the resistance rises, like the fourth comparative example, when carrying out the aging treatment to enable the fourth comparative example to cope with a high-voltage driving mode or operation. However, subjecting a lithium-ion secondary battery comprising the positive electrode according to the present invention on which the organic/inorganic coating layer is formed to the aging treatment is found out to result in making the problems avoidable.

### INDUSTRIAL APPLICABILITY

The positive electrode for lithium-ion secondary battery according to the present invention is useful as positive electrodes for lithium-ion secondary batteries utilized for driving the motors of electric automobiles and hybrid automobiles, and for personal computers, portable communication gadgets, home electric appliances, office devices, industrial instruments, and so forth. In particular, the lithium-ion secondary batteries are usable suitably for driving the motors of electric automobiles and hybrid automobiles requiring large capacities and large outputs.

1. A positive electrode for lithium-ion secondary battery comprising:
a current collector; and
a positive-electrode active-material layer bound together onto the current collector;
the positive-electrode active-material layer comprising: positive-electrode active-material particles including an Li compound or solid solution selected from the group consisting of LixNiaCobMndO2, LixCobMncO2, LixNiaMncO2, LixNiaCobO2 and Li2MnO3 (note that 0.5≦“x”≦1.5, 0.1≦“a”<1, 0.1≦“b”<1 and 0.1≦“c”<1); a binding portion not only binding the positive-electrode active-material particles together one another but also binding the positive-electrode active-material particles together with the current collector; and an organic/inorganic coating layer covering at least parts of surface of the positive-electrode active-material particles at least;
the organic/inorganic coating layer including: at least one optional polymer selected from polymers with at least one member selected from the group consisting of amino groups, imino groups, imide groups and maleimide groups; and at least one optional metal selected from the group consisting of alkali metals, alkaline-earth metals and rare-earth elements.

2. The positive electrode for lithium-ion secondary battery as set forth in claim 1, wherein a thickness of said organic/inorganic coating layer is 10 nm or less.

3. The positive electrode for lithium-ion secondary battery as set forth in claim 1, wherein said positive-electrode active-material particles are LixNiaCobMndO2.

4. The positive electrode for lithium-ion secondary battery as set forth in claim 1, wherein said optional polymer is polyethyleneimine.

5. The positive electrode for lithium-ion secondary battery as set forth in claim 1, wherein said organic/inorganic coating layer further includes a lithium compound exhibiting a higher oxidation-reaction potential than a carbonate-based electrolytic solution does.

6. The positive electrode for lithium-ion secondary battery as set forth in claim 1 further comprising a second organic coating layer on a surface of said organic/inorganic coating layer.

7. A secondary-battery positive-electrode production process for the positive electrode as set forth in claim 1, the production process comprising the steps of:
forming a positive-electrode active-material layer by applying a slurry onto a surface of a current collector and then drying the slurry thereon, the slurry comprising a binding agent, and positive-electrode active-material particles including an Li compound or solid solution selected from the group consisting of LixNiaCobMndO2, LixCobMncO2, LixNiaMncO2, LixNiaCobO2 and Li2MnO3 (note that 0.5≦“x”≦1.5, 0.1≦“a”<1, 0.1≦“b”<1 and 0.1≦“c”<1); and
forming an organic/inorganic coating layer by applying a mixed solution onto the positive-electrode active-material layer and then drying the mixed solution thereon, the mixed solution comprising a solvent, at least one optional polymer dissolved in the solvent and including a polymer selected from polymers with at least one member selected from the group consisting of amino groups, imino groups, imide groups and maleimide groups, and a compound dissolved in the solvent and including at least one optional metal selected from the group consisting of alkali metals, alkaline-earth metals and rare-earth elements.

8. The secondary-battery positive-electrode production process as set forth in claim 7, wherein the step of applying said mixed solution onto said positive-electrode active-material layer is carried out by a dipping method.

9. The secondary-battery positive-electrode production process as set forth in claim 7, wherein said optional polymer is polyethyleneimine, and is included in an amount of from 0.1 to 5% by mass in said mixed solution.

10. A lithium-ion secondary battery comprising said positive electrode as set forth in claim 1.

11. The lithium-ion secondary battery as set forth in claim 10 exhibiting a battery voltage of 4.3 V or more when being charged.

12. A lithium-ion secondary battery comprising:
said positive electrode as set forth in claim 1;
a negative electrode; and
an electrolytic solution;
the lithium-ion secondary battery further comprising LiBF4 in the electrolytic solution.

13. The secondary-battery positive-electrode production process as set forth in claim 7, wherein said compound of the optional metal comprises a nitrate or acetate including said optional metal.

14. A process for producing a positive electrode for secondary battery, the positive electrode comprising:
a current collector; and
a positive-electrode active-material layer bound together onto the current collector;
the positive-electrode active-material layer comprising: positive-electrode active-material particles including an Li compound or solid solution selected from the group consisting of LixNiaCobMndO2, LixCobMncO2, LixNiaMncO2, LixNiaCobO2 and Li2MnO3 (note that 0.5≦“x”≦1.5, 0.1≦“a”<1, 0.1≦“b”<1 and 0.1≦“c”<1); a binding portion not only binding the positive-electrode active-material particles together one another but also binding the positive-electrode active-material particles together with the current collector; and an organic/inorganic coating layer covering at least parts of surface of the positive-electrode active-material particles at least;
the organic/inorganic coating layer including: at least one optional polymer selected from polymers with at least one member selected from the group consisting of amino groups, amide groups, imino groups, imide groups, maleimide groups, carboxyl groups and ether groups; and at least one optional metal selected from the group consisting of alkali metals, alkaline-earth metals and rare-earth elements;
the process comprising the steps of:
forming a positive-electrode active-material layer by applying a slurry onto a surface of the current collector and then drying the slurry thereon, the slurry comprising a binding agent, and positive-electrode active-material particles including an Li compound or solid solution selected from the group consisting of LixNiaCobMndO2, LixCobMncO2, LixNiaMncO2, LixNiaCobO2 and Li2MnO3 (note that 0.5≦“x”≦1.5, 0.1≦“a”<1, 0.1≦“b”<1 and 0.1≦“c”<1); and
forming an organic/inorganic coating layer by applying a mixed solution onto the positive-electrode active-material layer and then drying the mixed solution thereon, the mixed solution comprising a solvent, an optional polymer dissolved in the solvent and including a polymer selected from polymers with at least one member selected from the group consisting of amino groups, amide groups, imino groups, imide groups, maleimide groups, carboxyl groups and ether groups, and a nitrate or acetate dissolved in the solvent and including at least one optional metal selected from the group consisting of alkali metals, alkaline-earth metals and rare-earth elements.

15. A positive electrode for lithium-ion secondary battery comprising:
a current collector; and
a positive-electrode active-material layer bound together onto the current collector;
the positive-electrode active-material layer comprising: positive-electrode active-material particles including an Li compound or solid solution selected from the group consisting of LixNiaCobMndO2, LixCobMncO2, LixNiaMncO2, LixNiaCobO2 and Li2MnO3 (note that 0.5≦“x”≦1.5, 0.1≦“a”<1, 0.1≦“b”<1 and 0.1≦“c”<1); a binding portion not only binding the positive-electrode active-material particles together one another but also binding the positive-electrode active-material particles together with the current collector; and an organic/inorganic coating layer covering at least parts of surface of the positive-electrode active-material particles at least;
the organic/inorganic coating layer including: at least one optional polymer selected from polymers with at least one member selected from the group consisting of amino groups, imino groups, imide groups and maleimide groups; and at least one optional metal selected from the group consisting of alkali metals, alkaline-earth metals and rare-earth elements;
said organic/inorganic coating layer further including a lithium compound exhibiting a higher oxidation-reaction potential than a carbonate-based electrolytic solution does.
